(19) United States
(12) Patent Application Publication
(10) Pub. No.: US 2007/0086286 A1
(43) Pub. Date: Apr. 19, 2007

(54) WOBBLE SIGNAL SYNTHESIZER AND METHOD FOR GENERATING SYNTHESIZED WOBBLE SIGNAL SYNCHRONIZED WITH PHYSICAL WOBBLE SIGNAL THROUGH COMPARING PHASES OF BOTH LAND PRE-PIT SIGNAL AND SYNTHESIZED WOBBLE SIGNAL WITH A REFERENCE CLOCK

(76) Inventors: Bing-Yu Hsieh, Taipei City (TW); Hao-Cheng Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/163,357

(22) Filed: Oct. 17, 2005

(51) Int. Cl. G11B 7/00; G11B 27/36

(52) U.S. Cl. 369/44.13; 369/53.34

(57) ABSTRACT

A wobble signal synthesizer for generating a synthesized wobble signal synchronized with physical wobble signal is disclosed. The wobble signal synthesizer includes a variable-period signal generating module for generating the synthesized wobble signal; a first period calculating module, electrically coupled to the variable-period signal generating module, for calculating the number of periods of a second reference clock in a certain period of the synthesized wobble signal; a second period calculating module for calculating the number of periods of the second reference clock in a certain wobble period at a disc rotation speed; a comparison module, electrically coupled to the variable-period signal generating module, the first period calculating module, and the second period calculating module, for outputting the period error value; and a phase alignment module, electrically coupled to the variable-period signal generating module, for determining the phase error value.

### BACKGROUND

The present invention relates to a wobble signal synthesizer, and more specifically, to a wobble signal synthesizer for generating a wobble signal synchronized with physical wobble signal through comparing phases of both land pre-pit signal and synthesized wobble signal with a reference clock.

Conventionally, an optical recordable disc, such as CD−R(W), DVD−R(W), or DVD+R(W) has been widely utilized as a medium for recording data. Wobbling grooves are formed in a data-recording region of the blank disc such that they meander slightly to produce a physical wobble signal on the groove of a disc surface to provide a signal reference for disc rotation control or for clock recovery purpose. Data in the form of pit-land mark is recorded inside this wobble groove. In other words, the wobble groove defines a recording track. It is well known that the optical disc drive has a pick-up head, and the pick-up head is divided into four parts to receive reflected light from surface of the optical disc. The reflected light received by two parts in the same side are transformed into electrical signals and summed up respectively. Then differential push-pull process is performed to generate a sinusoidal signal, named extracted wobble signal. If there is a land pre-pit across the wobble groove, such as DVD−R(W) disc, a peak pulse will piggyback on the extracted wobble signal. By feeding the extracted push-pull signal into a slicer, the position of the land pre-pit is confirmed and the signal outputted from the slicer is named as land pre-pit signal.

When recording data onto this recording track, the wobble signal is detected from the wobble groove so as to control disc rotation and to generate a recording clock. Then, data can be appropriately recorded at a target recording position through decoding physical address information carried on land pre-pit signals(such as DVD−R(W)) or modulated wobble signals(such as CD−R(W) and DVD+R(W)).

Taking DVD−R(W) disc for example, the specification suggests that the center of 14T data sync signal need to be close with the first land pre-pit signal within the range of +7T˜−7T distance. In order to have good recording performance, disc rotation must synchronize with the recording clock. However, the information recording capacity of a DVDR(W) is much higher than the capacity of a conventional CD−R(W) disc, a track pitch of a DVD (which is a center-to-center distance between neighboring wobble grooves in the radial direction) is smaller than a track pitch of a CD−R disc. In a DVD, because of the smaller track pitch, the crosstalk of neighboring wobble grooves is not negligible.

In certain circumstances, when recording data onto a DVD, the extracted wobble signal (which is obtained from the DVD) may have significant variances in amplitude and phase due to the crosstalk of neighboring wobble grooves. When the crosstalk occurs due to the adjacent wobble grooves, the extracted wobble signal is interfered with by the wobble component generated from the adjacent wobble groove so that the amplitude and the phase will deviate, that is, the extracted wobble signal read by a optical disc drive does not exactly match to the physical wobble signal on the disc surface. In this case, it is difficult to produce a recording clock that is precisely synchronized with the rotation of the disc, if the recording clock is produced directly based on the extracted wobble signal.

In particular, the time delay and signal distortion of the processing circuits results in a mismatch between the extracted wobble signal and physical wobble signal. This mismatch effect causes a deviation in a disc rotation control signal because of a phase difference between the physical wobble signal recorded by wobble grooves on the optical disc and the extracted wobble signal generated from processing the extracted operation. Because the extracted wobble signal is corresponding to the clock signal generation and the physical wobble signal is corresponding to the position of the rotation of the disc, the phase of the clock signal is deviated from the phase of the rotation of the disc. Such a deviation causes the recording pits to be inaccurately formed on the recording track and degrades performance of the optical disc drive. For example, when recording data on the disc, the positions or lengths of the recorded pits are inaccurate as mentioned above. In this case, this will cause errors while reproducing information in accordance with the recorded pits, and greatly degrade the recording and reproducing quality.

In our invention, we provide a circuit architecture and method for generating a synthesized wobble signal synchronized with physical wobble signal for the optical disc drive to circumvent the effect of crosstalk or other non-ideal interference factors.

### SUMMARY

According to the claimed invention, a wobble signal synthesizer for generating a synthesized wobble signal synchronized with physical wobble signal is disclosed. The wobble signal synthesizer includes a variable-period signal generating module for generating the synthesized wobble signal; a first period calculating module, electrically coupled to the variable-period signal generating module, for calculating the number of periods of a second reference clock in a certain period of the synthesized wobble signal; a second period calculating module for calculating the number of periods of the second reference clock in a certain wobble period at a disc rotation speed; a comparison module, electrically coupled to the variable-period signal generating module, the first period calculating module, and the second period calculating module, for outputting the period error value; and a phase alignment module, electrically coupled to the variable-period signal generating module, for determining the phase error value.

According to the claimed invention, a method for generating a synthesized wobble signal synchronized with physical wobble signal is further disclosed. The method includes generating the synthesized wobble signal according to a first reference clock, a phase error value, and a period error value; calculating the number of periods of a second reference clock in certain period of the synthesized wobble signal to produce a first period number; calculating the number of periods of the second reference clock in a certain wobble period at a disc rotation speed to produce a second period number; determining the period error value according to the first and second period numbers; and determining the phase error value between a land pre-pit signal and the synthesized wobble signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a wobble signal synthesizer according to a first embodiment of the present invention.

FIG. 2 is a block diagram of a wobble signal synthesizer according to a second embodiment of the present invention.

FIG. 3 is a block diagram of a period decision circuit illustrated in FIG. 2.

FIG. 4 is a block diagram of a wobble signal synthesizer according to a third embodiment of the present invention.

FIG. 5 is a block diagram of a wobble period searching circuit illustrated in FIG. 4.

FIG. 6 is a block diagram of a wobble signal synthesizer according to a fourth embodiment of the present invention.

### DETAILED DESCRIPTION

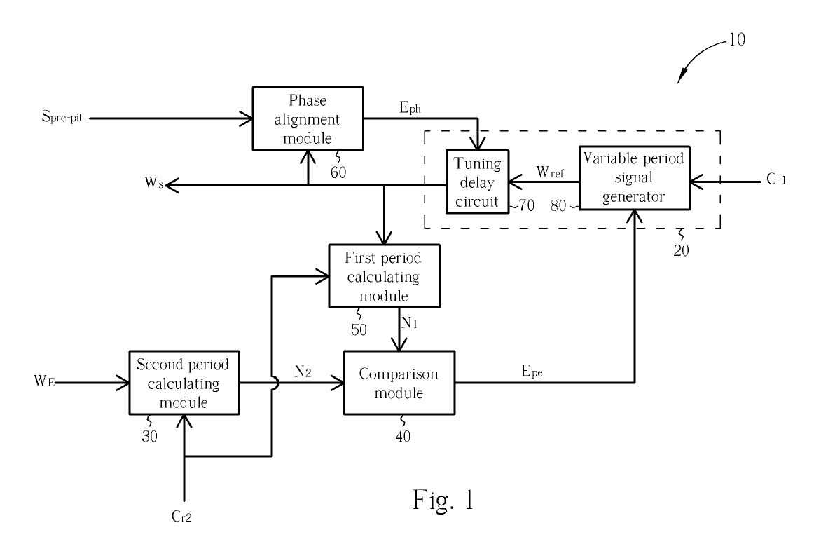

Please refer to FIG. 1. FIG. 1 is a block diagram of a wobble signal synthesizer 10 according to a first embodiment of the present invention. The wobble signal synthesizer 10 is able to generate a synthesized wobble signal W_{S} synchronized with a physical wobble signal on the surface of an optical disc by means of correcting the phase relation with detected physical land pre-pit. The wobble signal synthesizer 10 includes a variable-period signal generator 80 for generating a reference wobble signal W_{ref} according to a first reference clock Cᵣ₁ and a period error value Eₚₑ; a tuning delay circuit 70, electrically coupled to the variable-period signal generator 80, for adjusting phase of the reference wobble signal W_{ref} according to a phase error value Eₚₕ to generate the synthesized wobble signal W_{S}; a first period calculating module 50, electrically coupled to the tuning delay circuit 70, for calculating the number of periods of a second reference clock Cᵣ₂ in one period of the synthesized wobble signal W_{S} to produce a first period number N₁; a second period calculating module 30 for calculating the number of periods of the second reference clock Cᵣ₂ in one period of the extracted wobble signal W_{E} to produce a second period number N₂; a comparison module 40, electrically coupled to the variable-period signal generator 80, the first period calculating module 50, and the second period calculating module 30, for outputting the period error value Eₚₑ, determined in accordance with the first and the second period numbers N₁, N₂, to the variable-period signal generator 80; and a phase alignment module 60, electrically coupled to the tuning delay circuit 70, for determining the phase error value Eₚₕ according to a land pre-pit signal Sₚᵣₑ₋ₚᵢₜ and the synthesized wobble signal W_{S}, wherein the land pre-pit signal Sₚᵣₑ₋ₚᵢₜ is generated by detecting a center of a land pre-pit from a push-pull signal. Due to the pre-pit peak always appears on the physical wobble signal at regular phase, so the phase error between the synthesized wobble signal W_{S} and the land pre-pit signal Sₚᵣₑ₋ₚᵢₜ is capable of adjusting the phase error between the synthesized wobble signal W_{S} and the physical wobble signal. Please note that the tuning delay circuit 70 and the variable-period signal generator 80 are combined to form a variable-period signal generating module 20.

In this embodiment, the variable-period signal generator 80 receives a high-frequency source signal, the first reference clock Cᵣ₁, and multiplies a period of the first reference clock Cᵣ₁ by a factor determined by the period error value Eₚₑ to determine a period of the reference wobble signal W_{ref}. If the period error value Eₚₑ shows the period of the extracted wobble signal W_{E} is less than the period of the synthesized wobble signal W_{S}, i.e. N₂ is smaller than N₁, then the variable-period signal generator 80 decreases the factor for reducing the period of the reference wobble signal W_{ref} to match the period of the extracted wobble signal W_{E}. Otherwise, the variable-period signal generator 80 increases the factor for increasing the period of the reference wobble signal W_{ref} to match the period of the extracted wobble signal W_{E}. Next, the tuning delay circuit 70 adjusts phase of the reference wobble signal W_{ref} according to the phase error value Eₚₕ to generate the synthesized wobble signal W_{S}. In a DVD-R disc, it is well known that some land pre-pits stride across adjacent wobble tracks on the surface of the disc to illustrate the address information. According to the well-known land pre-pit characteristics, the phase alignment module 60 determines the phase error value Eₚₕ according to the land pre-pit signal Sₚᵣₑ₋ₚᵢₜ. Please note that the first and second reference clocks Cᵣ₁, Cᵣ₂ are allowed to be the same to reduce the circuit complexity of the wobble signal synthesizer 10.

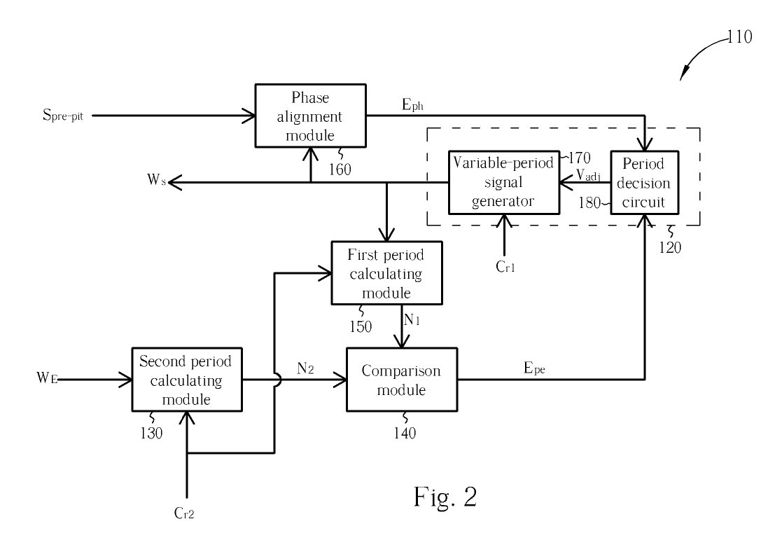

Please refer to FIG. 2. FIG. 2 is a block diagram of a wobble signal synthesizer 110 according to a second embodiment of the present invention. The wobble signal synthesizer 110 includes a variable-period signal generator 170 for generating a synthesized wobble signal W_{S} according to a first reference clock Cᵣ₁ and a period-adjusting signal V_{adj}; a period decision circuit 180, electrically coupled to a comparison module 140 and a phase alignment module 160, for generating the period-adjusting signal V_{adj} according to a phase error value Eₚₕ and a period error value Eₚₑ; a first period calculating module 150, electrically coupled to the variable-period signal generator 170, for calculating the number of periods of a second reference clock Cᵣ₂ in one period of the synthesized wobble signal W_{S} to produce a first period number N₁; a second period calculating module 130 for calculating the number of periods of the second reference clock Cᵣ₂ in one period of the extracted wobble signal W_{E} to produce a second period number N₂; a comparison module 140, electrically coupled to the period decision circuit 180, the first period calculating module 150, and the second period calculating module 130, for outputting the period error value Eₚₑ determined in accordance with the first and second period numbers N₁, N₂ to the period decision circuit 180; and a phase alignment module 160, electrically coupled to the period decision circuit 180, for determining the phase error value Eₚₕ according to the land pre-pit signal Sₚᵣₑ₋ₚᵢₜ and the synthesized wobble signal W_{S}. Similar to the first embodiment shown in FIG. 1, the variable-period signal generator 170 and the period decision circuit 180 are combined to act as a variable-period signal generating module 120 and the land pre-pit signal Sₚᵣₑ₋ₚᵢₜ is generated by detecting a center of a land pre-pit peak of the extracted wobble signal W_{E}.

It can be easily seen that the difference between the first and second embodiments is the configuration of the variable-period signal generating module. In the first embodiment, the variable-period signal generating module 20 processes the period error value Eₚₑ and the phase error value Eₚₕ separately in two circuit blocks, i.e. the variable-period signal generator 80 and the tuning delay circuit 70. In the second embodiment, however, the variable-period signal generating module 120 processes the period error value Eₚₑ and the phase error value Eₚₕ in the same circuit block, i.e. the period decision circuit 180.

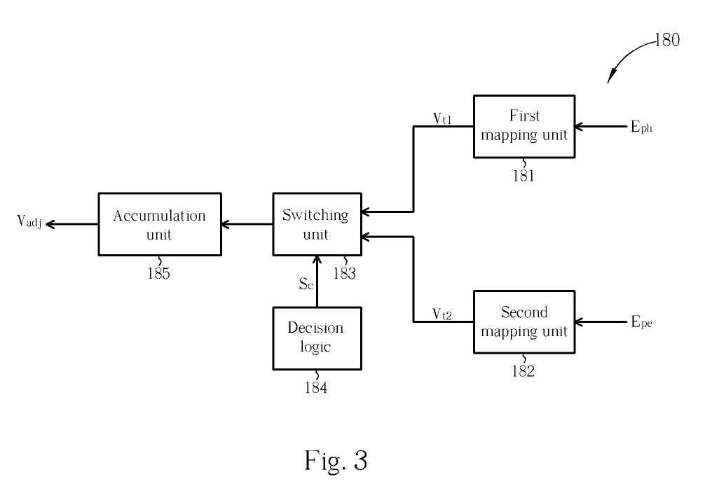

There are many ways to implement the period decision circuit 180, and an example for illustrative purposes is disclosed as follows. Please refer to FIG. 3. FIG. 3 is a block diagram of the period decision circuit 180 shown in FIG. 2. The period decision circuit 180 includes a first mapping unit 181, electrically coupled to the phase alignment module 160, for converting the phase error value Eₚₕ into a first tuning value Vₜ₁; a second mapping unit 182, electrically coupled to the comparison module 140, for converting the period error value Eₚₑ into a second tuning value Vₜ₂; a switching unit 183, electrically coupled to the first and second mapping units 181 and 182, for selectively utilizing either the first tuning value Vₜ₁ or the second tuning value Vₜ₂ as an output according to a control signal S_{C}; a decision logic 184, electrically coupled to the switching unit 183, for generating the control signal S_{C}; and an accumulation unit 185, electrically coupled to the switching unit 183, for accumulating the output of the switching unit 183 to determine the period-adjusting signal V_{adj}. In this embodiment, the control signal S_{C} controls the switching unit 183 to select the first tuning value Vₜ₁ as the output when the period error value Eₚₑ falls in a target range, and the control signal S_{C} controls the switching unit 183 to select the second tuning value Vₜ₂ as the output when the period error value Eₚₑ does not fall in the target range. In short, the period decision circuit 180 firstly adjusts the period of the period-adjusting signal V_{adj} according to the period error value Eₚₑ when the period error between the synthesized wobble signal W_{S} and the extracted wobble signal W_{E} is acceptable (i.e. the period error value Eₚₑ falls in the target range). Then, the period decision circuit 180 turns to adjust the phase of the period-adjusting signal V_{adj} according to the phase error value Eₚₕ.

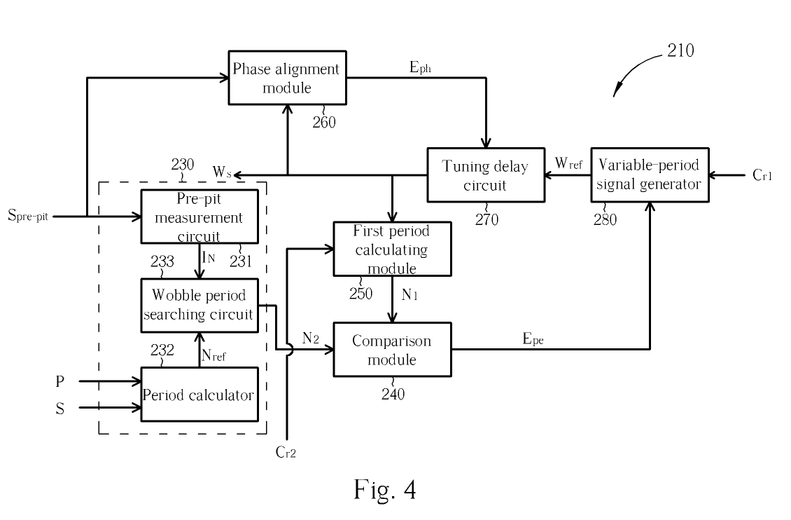

Please refer to FIG. 4. FIG. 4 is a block diagram of a wobble signal synthesizer 210 according to a third embodiment of the present invention. The wobble signal synthesizer 210 includes a variable-period signal generator 280 for generating a reference wobble signal W_{ref} according to a first reference clock Cᵣ₁ and a period error value Eₚₑ; a tuning delay circuit 270, electrically coupled to the variable-period signal generator 280, for adjusting phase of the reference wobble signal W_{ref} according to a phase error value Eₚₕ to generate the synthesized wobble signal W_{S}; a first period calculating module 250, electrically coupled to the tuning delay circuit 270, for calculating the number of periods of a second reference clock Cᵣ₂ in one period of the synthesized wobble signal W_{S} to produce a first period number N₁; a pre-pit measurement circuit 231 for detecting a time interval I_{N} between two land pre-pits; a period calculator 232 for predicting period of the extracted wobble signal according to position P and rotation speed S of optical pick-up head, and producing a reference period number N_{ref}; a wobble period searching circuit 233, electrically coupled to the pre-pit measurement circuit 231, the period calculator 232, and a comparison module 240, for determining the second period number N₂ according to the interval I_{N} determined by the pre-pit measurement circuit 231 and the reference period number N_{ref} determined by the period calculator 232; a comparison module 240, electrically coupled to the variable-period signal generator 280, the first period calculating module 250, and the wobble period searching circuit 233, for outputting the period error value Eₚₑ determined in accordance with the first and second period numbers N₁, N₂ to the variable-period signal generator 280; and a phase alignment module 260, electrically coupled to the tuning delay circuit 270, for determining the phase error value Eₚₕ according to the land pre-pit signal Sₚᵣₑ₋ₚᵢₜ and the synthesized wobble signal W_{S}. Please note that the pre-pit measurement circuit 231, the wobble period searching circuit 233, and the period calculator 232 are combined to form a function block called the second period calculating module 230. As shown in FIG. 4, the land pre-pit signal is transmitted into the pre-pit measurement circuit 231, the pre-pit measurement circuit 231 detects two nearby land pre-pits and measures the time interval I_{N} between two nearby land pre-pits. Reference period number of one equivalent wobble signal period is able to be predicted through a lookup table based on position and rotation speed of the optical pick-up head; therefore, the period of equivalent wobble signal is determined through detecting the interval I_{N}.

From comparing FIG. 4 with FIG. 1, it is obvious that the difference between the two diagrams is the configuration of the second period calculating module. FIG. 1 can be applied to any types of calculators to calculate the number of periods of the second reference clock Cᵣ₂ in one period of the extracted wobble signal W_{E} to produce the second period number N₂. However, in FIG. 4, the pre-pit measurement circuit 231 detects the interval I_{N} between two land pre-pits. Because the specification promises integer numbers of physical wobble periods placed between two land pre-pit signals, the interval I_{N}, therefore, represents a plurality of periods of the wobble signals. The objective of the period calculator 232 is to provide an initial, referable reference period number of one equivalent wobble signal. Then, the wobble period searching circuit 233 is able to determine the precise period number, second period number N₂, according to the interval I_{N} and the reference period number N_{ref}. Please note that it is possible to remove the period calculator 232 from the second period calculating module 230. For this case, the wobble period searching circuit 233 determines the second period number N₂ only according to the interval I_{N} and the second reference clock Cᵣ₂. The benefit of utilizing the period calculator 232 is increasing the accuracy of the second period number N₂.

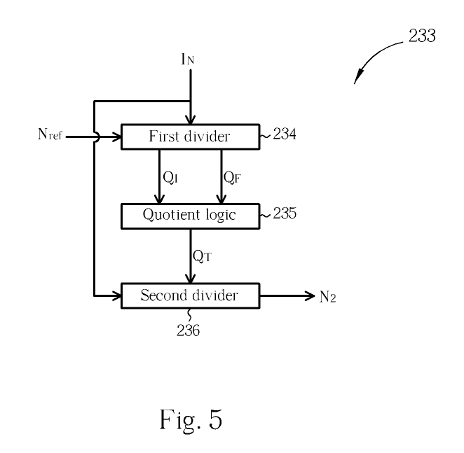

The above-mentioned wobble period searching circuit 233 in particular works more efficiently if implemented by digital circuits. Please refer to FIG. 5. FIG. 5 is a block diagram of the wobble period searching circuit 233 shown in FIG. 4. The wobble period searching circuit 233 includes a first divider 234 for dividing the interval I_{N} by the reference period number N_{ref} to determine an integer quotient Q_{I} and a fractional quotient Q_{F}; a quotient logic 235, electrically coupled to the first divider 234, for determining a target integer quotient Q_{T} according to the integer quotient Q_{I} and a fractional quotient Q_{F}; and a second divider 236, electrically coupled to the quotient logic 235, for dividing the interval I_{N} by the target integer quotient Q_{T} to determine the second period number N₂. Firstly, the first divider 234 divides the interval I_{N} by the reference period number N_{ref} to obtain the integer quotient Q_{I} and the fractional quotient Q_{F}. Because the reference period number N_{ref} is an initial, predicted value, the fractional quotient Q_{F} is referenced to further tune the integer quotient Q_{I}. In other words, the smaller the fractional quotient Q_{F} is, the more accurate the reference period number N_{ref}. Next, the quotient logic 235 compares the fractional quotient Q_{F} with an upper limit and a lower limit. If the fractional quotient Q_{F} is greater than the upper limit, the quotient logic 235 adds one to the integer quotient, i.e. Q_{I}+1, as the target integer quotient Q_{T}; if the fractional quotient Q_{F} is less than a lower limit, the quotient logic 235 sets the integer quotient Q_{I} as the target integer quotient Q_{T}; and if the fractional quotient Q_{F} is between the upper limit and the lower limit, the quotient logic 235 abandons the integer quotient Q_{I} and the fractional quotient Q_{F}, and then re-determines the target integer quotient Q_{T}. Finally, the second divider 236 divides the interval I_{N} by the target integer quotient Q_{T} to obtain a precise second period number N₂ that stands for the number of periods of the second reference clock Cᵣ₂ in one period of the extracted wobble signal W_{E}.

One advantage of the wobble signal synthesizer 210 is that the wobble period searching circuit 233 is capable of determining the second period number N₂ by averaging a plurality of calculated period numbers corresponding to different periods of the land pre-pit signals. For example, the wobble period searching circuit 233 determines a first number N₂₁ according to the first interval I_{N1}, and the first reference period number N_{ref1}, a second number N₂₂ according to the second interval I_{N2} and the second reference period number N_{ref2}, and a third number N₂₃ according to the third interval I_{N3} and the third reference period number N_{ref3}. Then the wobble period searching circuit 233 averages the first number N₂₁, the second number N₂₂, and the third number N₂₃ to output the wanted second period number N₂. Therefore, the influence caused by jitters or noise is greatly reduced and the accuracy of the second period number N₂ is further increased.

Please note that the wobble period searching circuit 233 discussed above is not limited in digital or analog circuits. In fact, if digital circuits construct the wobble period searching circuit 233, it is easier to be accomplished via applying a processor connecting with a storage unit. The storage unit storing a searching program has the ability to calculate the second period number N₂. The processor then only has to execute the searching program to determine the second period number.

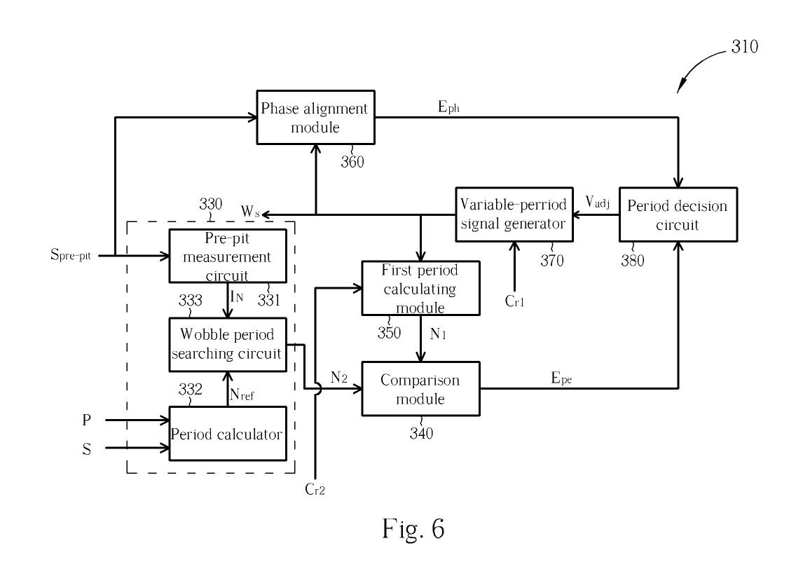

Please refer to FIG. 6. FIG. 6 is a block diagram of a wobble signal synthesizer 310 according to a fourth embodiment of the present invention. The wobble signal synthesizer 310 includes a period decision circuit 380, a variable-period signal generator 370, a first period calculating module 350, a comparison module 340, a phase alignment module 360, an pre-pit measurement circuit 331, a wobble period searching circuit 333, and a period calculator 332. The pre-pit measurement circuit 331, the wobble period searching circuit 333, and the period calculator 332 are combined to form a second period calculating module 330.

Comparing embodiments shown in FIG. 2 and FIG. 6, the only difference is the second period calculating module. Due to functions of other blocks in FIG. 6 being the same as those in FIG. 2, further description of these other blocks is omitted for brevity. In this embodiment, the operation of the second period calculating module 330 shown in FIG. 6 is the same as the second period calculating module 230 shown in FIG. 4. That is, the wobble signal synthesizer 310 in the fourth embodiment is established from the wobble signal synthesizer 110 by replacing the second period calculating module 130 with the second period calculating module 230 shown in FIG. 4.

Due to dynamically comparing the period error and phase error between the synthesized wobble signal, the extracted wobble signal and the land pre-pit signal, the synthesized wobble signal is tuned immediately. Moreover, because the synthesized wobble signal is generated by an independent, high frequency reference clock, and not by the extracted wobble signal directly, the wobble signal synthesizer can be constructed by digital circuits, meaning that the digital control is utilized. Thus, the wobble signal synthesizer is capable of averaging a plurality of periods of the extracted wobble signal to generate the synthesized wobble signal, which reduces jitters or noise effect and increases the performance of the synthesized wobble signal.

Because the extracted wobble signal W_{E} is directly extracted from surface of the optical disc, the phase is interfered by the crosstalk. However, the frequency is not interfered by the crosstalk, still remains the same to the physical wobble signal. It is therefore the present invention utilizes the extracted wobble signal W_{E} to be a reference signal to calibrate the synthesized wobble signal W_{S}, additionally, the land pre-pit signal represents the rotation velocity of the optical disc, so the land pre-pit signal is also capable of synchronizing the extracted wobble signal W_{E} and the physical wobble signal. On the other side, due to the crosstalk cannot interfere the land pre-pit signal, the phase of the synthesized wobble signal W_{S} is calibrated by the land pre-pit signal. In conclusion, the present invention provide a synthesized wobble signal synchronized with the rotation speed of the optical disc, therefore the synthesized wobble signal is suitable to be reference as a recording clock or other applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wobble signal synthesizer for generating a synthesized wobble signal synchronized with the physical wobble signal, the wobble signal synthesizer comprising:a variable-period signal generating module for generating the synthesized wobble signal according to a first reference clock, a phase error value, and a period error value;
a first period calculating module, electrically coupled to the variable-period signal generating module, for calculating the number of periods of a second reference clock in a certain period of the synthesized wobble signal to produce a first period number;
a second period calculating module for calculating the number of periods of the second reference clock in a certain wobble period at a disc rotation speed to produce a second period number;
a comparison module, electrically coupled to the variable-period signal generating module, the first period calculating module, and the second period calculating module, for outputting the period error value determined in accordance with the first and second period numbers to the variable-period signal generating module; and
a phase alignment module, electrically coupled to the variable-period signal generating module, for determining the phase error value according to a land pre-pit signal and the synthesized wobble signal.

2. The wobble signal synthesizer of claim 1, wherein the variable-period signal generating module comprises:
a variable-period signal generator, electrically coupled to the comparison module, for generating a reference wobble signal according to the first reference clock and the period error value; and
a tuning delay circuit, electrically coupled to the variable-period signal generator and the phase alignment module, for adjusting phase of the reference wobble signal according to the phase error value to generate the synthesized wobble signal.

3. The wobble signal synthesizer of claim 2, wherein the variable-period signal generator multiplies a period of the first reference clock by a factor determined by the period error value to determine a period of the reference wobble signal.

4. The wobble signal synthesizer of claim 1, wherein the variable-period signal generating module comprises:
a period decision circuit, electrically coupled to the comparison module and the phase alignment module, for determining a period-adjusting signal according to the period error value and the phase error value; and
a variable-period signal generator, electrically coupled to the period decision circuit, for generating the synthesized wobble signal according to the first reference clock and the period-adjusting signal.

5. The wobble signal synthesizer of claim 4, wherein the variable-period signal generator multiplies a period of the first reference clock by a factor determined by the period-adjusting signal to determine a period of the synthesized wobble signal.

6. The wobble signal synthesizer of claim 4, wherein the period decision circuit comprises:
a first mapping unit, electrically coupled to the phase alignment module, for converting the phase error value into a first tuning value;
a second mapping unit, electrically coupled to the comparison module, for converting the period error value into a second tuning value;
a switching unit, electrically coupled to the first and second mapping units, for selectively utilizing either the first tuning value or the second tuning value as an output according to a control signal;
a decision logic, electrically coupled to the switching unit, for generating the control signal, wherein the control signal controls the switching unit to select the first tuning value as the output when the period error value falls in a target range, and the control signal controls the switching unit to select the second tuning value as the output when the period error value does not fall in the target range; and
an accumulation unit, electrically coupled to the switching unit, for accumulating the output of the switching unit to determine the period-adjusting signal.

7. The wobble signal synthesizer of claim 1, wherein the second period calculating module comprises
an pre-pit measurement circuit for detecting an interval between two land pre-pit signals; and
a wobble period searching circuit, electrically coupled to the pre-pit measurement circuit and the comparison module, for determining the second period number according to the interval determined by the pre-pit measurement circuit and a reference period number.

8. The wobble signal synthesizer of claim 7, wherein the second period calculating module further comprises:
a period calculator, electrically coupled to the wobble period searching circuit, for predicting period of certain equivalent wobble signal according to position of optical pick-up head and rotation speed of disc to produce the reference period number.

9. The wobble signal synthesizer of claim 7, wherein the wobble period searching circuit determines the second period number by averaging a plurality of calculated period numbers corresponding to different periods of the extracted wobble signal.

10. The wobble signal synthesizer of claim 7, wherein the wobble period searching circuit comprises:
a first divider for dividing the interval by the reference period number to determine an integer quotient and a fractional quotient;
a quotient logic, electrically coupled to the first divider, for determining a target integer quotient according to the integer quotient and a fractional quotient; and
a second divider, electrically coupled to the quotient logic, for dividing the interval by the target integer quotient to determine the second period number.

11. The wobble signal synthesizer of claim 10, wherein if the fractional quotient is greater than an upper limit, the quotient logic sets the integer quotient plus one to the target integer quotient, if the fractional quotient is less than a lower limit, the quotient logic sets the integer quotient to the target integer quotient, and if the fractional quotient is between the upper limit and the lower limit, the wobble period searching circuit abandons the integer quotient and the fractional quotient, and determines the second period number again.

12. The wobble signal synthesizer of claim 7, wherein the wobble period searching circuit comprises a processor and a storage unit storing a searching program, and the processor executes the searching program to determine the second period number.

13. The wobble signal synthesizer of claim 12, wherein the processor executes the searching program circuit to determine the second period number by averaging a plurality of calculated period numbers corresponding to different periods of the extracted wobble signal.

14. The wobble signal synthesizer of claim 12, wherein the processor executes the searching program to determine the second period number by:
dividing the interval by the reference period number to determine an integer quotient and a fractional quotient;
determining a target integer quotient according to the integer quotient and a fractional quotient; and
dividing the interval by the target integer quotient to determine the second period number.

15. The wobble signal synthesizer of claim 1, wherein both the first and second reference clocks have the same period.

16. The wobble signal synthesizer of claim 1, wherein the land pre-pit signal is generated by detecting a center of a land pre-pit peak of the extracted wobble signal.

17. A method for generating a synthesized wobble signal synchronized with the physical wobble signal, the method comprising:
generating the synthesized wobble signal according to a first reference clock, a phase error value, and a period error value;
calculating the number of periods of a second reference clock in a certain period of the synthesized wobble signal to produce a first period number;
calculating the number of periods of the second reference clock in a certain wobble period at a disc rotation speed to produce a second period number;
determining the period error value according to the first and second period numbers; and
determining the phase error value between a land pre-pit signal and the synthesized wobble signal.

18. The method of claim 17, wherein the step of generating the synthesized wobble signal according to a first reference clock, a phase error value, and a period error value comprises:
generating a reference wobble signal according to the first reference clock and the period error value; and
adjusting phase of the reference wobble signal according to the phase error value to generate the synthesized wobble signal.

19. The method of claim 18, wherein a period of the reference wobble signal is determined by multiplying a period of the first reference clock by a factor determined by the period error value.

20. The method of claim 17, wherein the step of generating the synthesized wobble signal according to a first reference clock, a phase error value, and a period error value comprises:
determining a period-adjusting signal according to the period error value and the phase error value; and
generating the synthesized wobble signal according to the first reference clock and the period-adjusting signal.

21. The method of claim 20, wherein a period of the synthesized wobble signal is determined by multiplying a period of the first reference clock by a factor determined by the period-adjusting signal.

22. The method of claim 20, wherein the step of determining a period-adjusting signal according to the period error value and the phase error value comprises:
converting the phase error value into a first tuning value for the period-adjusting signal;
converting the period error value into a second tuning value for the period-adjusting signal;
selectively utilizing either the first tuning value or the second tuning value as an output according to a control signal;
generating the control signal for controlling the switching unit to select the first tuning value as the output when the period error value falls in a target range, and controlling the switching unit to select the second tuning value as the output when the period error value does not fall in the target range; and
accumulating the output of the switching unit to determine the period-adjusting signal.

23. The method of claim 17, wherein the step of calculating the number of periods of the second reference clock in one period of the extracted wobble signal to produce a second period number comprises:
detecting an interval between two land pre-pit signals; and
determining the second period number according to the interval and a reference period number.

24. The method of claim 23, wherein the step of calculating the number of periods of the second reference clock in certain quivalent wobble period to produce a second period number further comprises:
predicting period of certain equivalent wobble signal according to position of optical pick-up head and rotation speed of disc to produce the reference period number.

25. The method of claim 23, wherein the second period number is determined by averaging a plurality of calculated period numbers corresponding to different periods of the extracted wobble signal.

26. The method of claim 23, wherein the step of detecting an interval between two land pre-pits of the extracted wobble signal comprises:
dividing the interval by the reference period number to determine an integer quotient and a fractional quotient;
determining a target integer quotient according to the integer quotient and the fractional quotient; and
dividing the interval by the target integer quotient to determine the second period number.

27. The method of claim 26, wherein if the fractional quotient is greater than an upper limit, the integer quotient adds one to the target integer quotient, if the fractional quotient is less than a lower limit, the integer quotient is set to the target integer quotient, and if the fractional quotient is between the upper limit and the lower limit, the integer quotient and the fractional quotient are abandoned and then determined again.

28. The method of claim 23, wherein the second period number is determined by executing the searching program stored in a storage unit by a processor.

29. The method of claim 17, wherein both the first and second reference clocks has the same period.

30. The method of claim 17, wherein the land pre-pit signal is generated by detecting a center of a land pre-pit peak of the extracted wobble signal.
